(19) United States
(12) Patent Application Publication
(10) Pub. No.: US 2003/0162058 A1
(43) Pub. Date: Aug. 28, 2003

(54) Method and a device for controlling fuel cells

(76) Inventors: Roberto Dorigo, Caorle (IT); Salvatore Pappalardo, Padova (IT)

Correspondence Address: MERCHANT & GOULD PC, P.O. BOX 2903, MINNEAPOLIS, MN, 55402-0903, US

(21) Appl. No.: 10/311,729

(22) PCT Filed: Feb. 23, 2001
(86) PCT No.: PCT/IT01/00088

(30) Foreign Application Priority Data
Dec. 15, 2000 (IT) PD2000A000281

(51) Int. Cl. H01M 8/04; G05B 11/32

(52) U.S. Cl. 429/13; 429/17; 429/23; 429/24; 700/286

(57) ABSTRACT

A method for the operative control of fuel cells (2) is described and comprises the steps of providing an electronic control unit (8), regulating the quantity of fuel and/or supporter of combustion which flows per unit of time in a supply circuit (4, 5) of the fuel cell (2) by regulation means (6, 7, 13, 14, 16, 17), obtaining a temperature signal (T) from the cell (2), obtaining a power signal (W) from a closed circuit (11) including the cell, supplying the signals to the electronic control unit (8), and making the regulation means (6, 7, 13, 14, 16, 17) subject to the electronic control unit (8), the regulation of the quantity of fuel and/or supporter of combustion being of the modulating type, and the modulation taking place in dependence on the temperature and power signals. The invention is also directed towards a device (1, 100) operating in accordance with the method.

### DESCRIPTION

1. Technical Field

The present invention relates to a method of controlling fuel cells according to the preamble to main claim 1. The invention also relates to a device designed for the application of the method of the invention.

2. Background Art

As is known, in a fuel cell, chemical energy is converted into electrical energy by means of two electrodes (an anode and a cathode) between which an electrolyte is disposed.

In order to function and to produce energy, the cell must be supplied continuously with a fuel, generally hydrogen, and, separately, with a supporter of combustion, such as oxygen. The fuel is supplied at the anode, where it gives up its electron; the protons then pass through the electrolyte whilst the electrons create a current which can be utilized and then return to the cathode where, together with the protons and the oxygen, they form water molecules.

Within the technical field described, the need for effective control of the production of electrical energy delivered by the cell is known.

Generally, this control is performed by means of a valve acting on the fuel supply to permit or prevent the flow of fuel to the cell. Since this type of control does not permit control of the quantity of fuel admitted, it leads to wastage of hydrogen and to a non-optimal yield of the reaction which takes place inside the cell.

### DISCLOSURE OF INVENTION

A main object of the present invention is to provide a method for the operative control of a fuel cell which is designed to overcome the limitations mentioned with reference to the prior art.

This object and others which will become clearer from the following description are achieved by the invention by means of a method and a device having the characteristics defined in the appended claims.

### BRIEF DESCRIPTION OF DRAWINGS

The characteristics and the advantages of the invention will become clearer from the detailed description of some preferred embodiments thereof, described by way of non-limiting example with reference to the appended drawings in which:

FIG. 1 is a block diagram relating to the functioning of a device for controlling a fuel cell, operating in accordance with the method of the invention,

FIG. 2 is a variant of the control device of FIG. 1.

### BEST WAYS OF IMPLEMENTING THE INVENTION

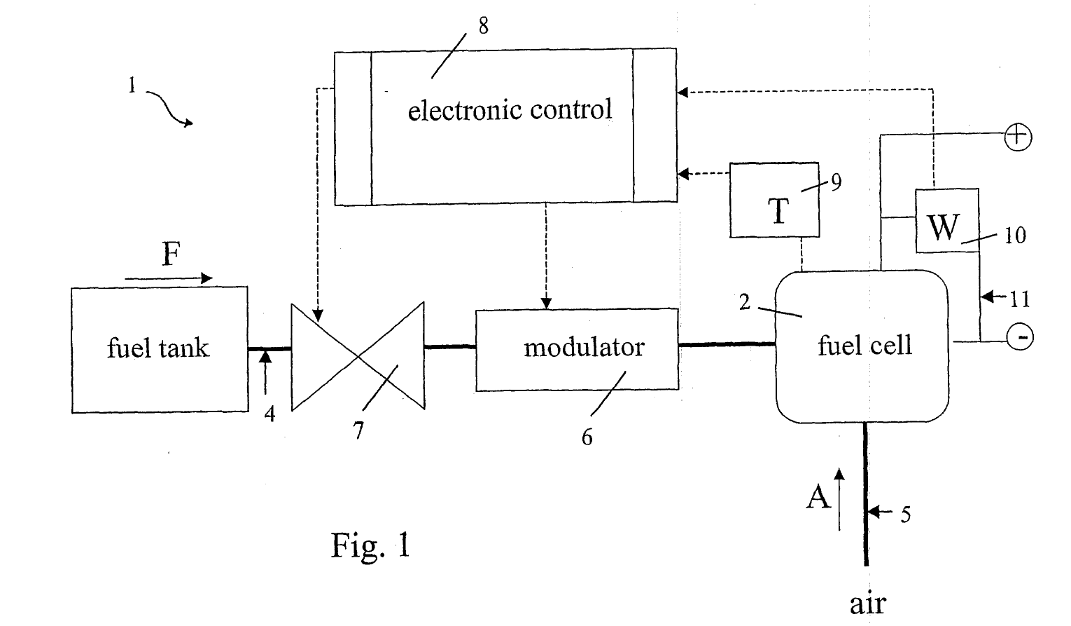

With reference to FIG. 1, a device for the operative control of a fuel cell 2 of known type, operating in accordance with the method of the present invention, is generally indicated 1.

The device 1 comprises a supply circuit for the cell 2, divided into two separate ducts 4, 5 along which a fuel F, for example hydrogen, and air A, of which the oxygen fraction acts as a supporter of combustion, are made to flow, respectively.

The first duct 4 of the supply circuit comprises means for regulating the quantity of fuel F which flows in the duct 4 per unit of time. The fuel-regulation means comprise a first modulator 6 and a first on-off valve 7 which is disposed upstream of the modulator 6, the term “upstream” relating to the direction of flow of the fuel F towards the cell 2.

The modulator 6 is arranged to vary the flow-rate of fuel whereas the flow of fuel F in the duct 4 can be completely shut off by means of the on-off valve 7.

The device 1 also comprises an electronic control unit 8 by which the above-described fuel-regulation means are operatively controlled, by means of an output signal. The unit 8 is operatively connected to a temperature sensor 9 which can measure the internal temperature (T) of the cell 2, and to a power sensor 10 for measuring the power (w) produced in a closed circuit 11 including the cell 2. The circuit 11 is the circuit through which the current produced by the fuel cell 2 flows when the cell is in operation.

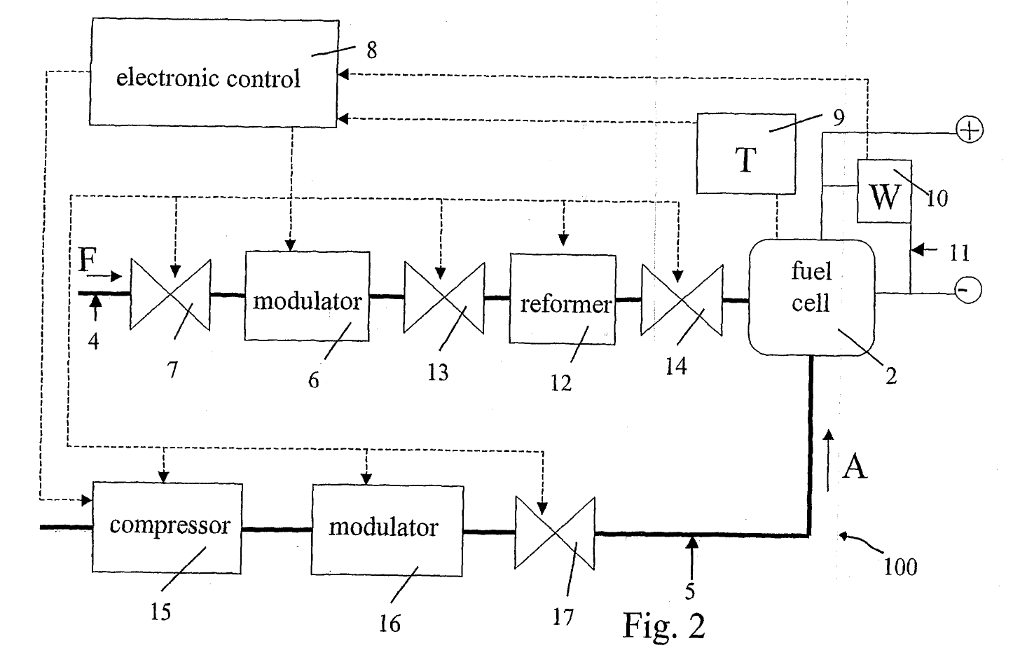

FIG. 2 shows a variant of the device according to the invention, generally indicated 100, in which details similar to those of the previous embodiment are indicated by the same reference numerals.

In the device 100, the fuel F which, in this case, is a natural gas or a hydrocarbon, is admitted along the first duct 4, the quantity of fuel flowing per unit of time being regulated by the first modulator 6 and the first on-off valve 7, as described above. Downstream of the modulator 6, in the duct 4, there is a reformer 12 by means of which the hydrogen to be admitted to the cell 2 as fuel is produced, in known manner.

The modulator 6 may also be arranged downstream of the reformer 12.

In the device 100, the means for regulating the fuel F, which are disposed in the first duct 4, also comprise a second and a third on-off valve 13, 14 which are disposed in the first duct 4 between the modulator 6 and the reformer 12 and downstream of the reformer 12, respectively, and, together with the reformer 12, are operatively controlled by the electronic control unit 8.

The device 100 also comprises, in the second duct 5 for supplying the supporter of combustion A, a compressor 15 for admitting air to the duct 5 under pressure and means for regulating the supporter of combustion, in turn comprising a second modulator 16 for modulating the quantity of supporter of combustion per unit of time and a fourth on-off valve 17, disposed in series with one another. The means for regulating the supporter of combustion are also operatively controlled by the control unit.

The devices 1 and 100 are formed for operating in accordance with the method of the invention.

According to this method, with reference to the device 1, the cell 2 is supplied with fuel F, in particular, with hydrogen, which flows along the first duct 4. The quantity of fuel which reaches the cell is modulated by means of the first modulator 6, as explained below.

The cell 2 is also supplied with the supporter of combustion A, in particular with air, flowing along the second duct 5.

By virtue of the chemical reaction which takes place inside the cell 2, an electrical current is produced and flows in the electrical circuit 11. Measurements of the internal temperature (T) of the cell 2 and of the power (W) delivered by the circuit 11 are taken by means of a temperature sensor 9 and a power sensor 10; the data relating to the measurements taken is sent, in the form of electrical signals, to the control unit 8 which processes it and in turn sends a control signal to the first modulator 6.

The quantity of fuel F which flows along the first duct 4 per unit of time is thus modulated by the first modulator 6 in dependence on the values of the temperature of the cell 2 and of the electrical power produced thereby.

Moreover, in the event of anomalies in the operation of the cell 2, such as, for example, temperature values T>Tmax (where Tmax is a maximum temperature value for the safety of the cell) or power W=0 or W>Wmax (where Wmax is a safety maximum power value) an output signal is sent from the control unit 8 to the first on-off valve 7, which is also subject to the unit 8, in order operatively to close the first duct 4.

The device 100 is supplied with fuel F, in this case, with natural gas or hydrocarbon, which flows through the duct 4, and with air which flows through the duct 5.

The quantity of fuel F which flows through the duct 4 is regulated by regulation means including an on-off valve 7 and by a modulator operatively controlled by the unit 8. The fuel F then undergoes a reforming process in the reformer 12 by means of which the hydrogen supplied to the cell 2 is produced.

The quantity of supporter of combustion A, pressurized by means of the compressor 15 and flowing along the second duct 5, is regulated by means of the second modulator 16 and the fourth on-off valve 17.

The reformer 12 and the second, third, and fourth on-off valves 13, 14, 17 are subject to the control unit 8. As described above, the control unit receives the data relating to the temperature and power measurements from the two sensors 9, 10, processes it, and sends an output signal for the control of one or more of the devices listed above. In the presence of data indicating a malfunction of the cell 2, one or more of the valves 7, 13, 14, 17 is operated so as to close the duct 4 and/or 5; during normal operation, the quantities both of fuel F and of supporter of combustion A supplied to the cell are modulated by the modulators 6, 16 according to the load requirements of the cell.

The invention thus achieves the objects proposed, affording many advantages over known solutions.

In the first place, the method and the device according to the invention enable the quantities of supporter of combustion and of fuel admitted to the cell to be modulated, improving its energy efficiency.

A second advantage is that it is possible to optimize the production of electrical energy by the cell and to vary its production, according to need.

Moreover, the ability to regulate both the fuel and the supporter of combustion enables the cell to be shut down more quickly in case of need, since the flow of both to the cell can be stopped.

Not the least advantage lies in the fact that improved safety of the cell in operation is achieved by virtue of several provisions for stopping the flow of fuel or of supporter of combustion in the event of breakdown.

1. A method for the operative control of fuel cells (2), comprising the steps of:
providing an electronic control unit (8),
regulating the quantity of fuel and/or supporter of combustion which flows per unit of time in a supply circuit (4, 5) of the fuel cell (2) by regulation means (6, 7, 13, 14, 16, 17),
obtaining a temperature signal (T) from the cell (2),
obtaining a power signal (W) from a closed electrical circuit (11) including the cell (2),
supplying the signals to the electronic control unit (8), and
making the regulation means (6, 7, 13, 14, 16, 17) subject to the electronic control unit (8), in which the regulation of the quantity of fuel and/or supporter of combustion is of the modulating type, and in which the modulation takes place in dependence on the temperature and power signals.

2. A method according to claim 1 in which the quantity of fuel is regulated downstream of a reforming process for producing hydrogen from natural gas or from hydrocarbons.

3. A method according to claim 1 or claim 2 in which the quantity of supporter of combustion is regulated downstream of a compressor (15).

4. A method according to claim 1 or claim 3 in which the quantity of fuel is regulated upstream of the reforming process.

5. A method according to one or more of the preceding claims in which the supply circuit (4, 5) can be shut off by means of at least one on-off valve (7, 13, 14, 17) and can be modulated by means of a modulator (6, 16).

6. A device (1, 100) for controlling fuel cells (2), comprising:
a circuit for the supply of fuel (4) and supporter of combustion (5) to the cell,
an electronic control unit (8),
regulation means (6, 7, 13, 14, 16, 17) for regulating the quantity of fuel and/or supporter of combustion, positioned in the supply circuit and operatively controlled by the electronic control unit (8),
temperature sensor means (9) for measuring the temperature (T) of the cell (2),
power sensor means (10) for measuring the power (W) in a closed circuit (11) including the cell (2), the temperature and power sensor means (9, 10) being connected to the electronic control unit (8), in which the regulation means (6, 7, 13, 14, 16, 17) are of the modulating type and comprise at least a first on-off valve (7, 13, 14, 17) and a first modulator (6, 16).

7. A device according to claim 6 in which the first on-off valve (7) is disposed in the fuel-supply circuit, upstream of the first modulator (6).

8. A device according to claim 6 or claim 7 in which the regulation means comprise a second on-off valve (13, 14) disposed in the fuel-supply circuit (4), downstream of the first modulator (6).

9. A device according to one or more of claims 6 to 8, comprising a reformer (12) disposed in the fuel-supply circuit (4) for producing hydrogen from natural gas or from hydrocarbons.

10. A device according to claim 9, comprising a third on-off valve (14) disposed in the fuel-supply circuit (4), downstream of the reformer (12).

11. A device according to one or more of claims 6 to 10, comprising a compressor (15), in the circuit (5) of the supporter of combustion.

12. A device according to one or more of claims 6 to 11 in which the regulation means comprise a second modulator (16), in the circuit (5) of the supporter of combustion.

13. A device according to claim 12 in which the second modulator (16) is disposed downstream of the compressor (15), in the circuit (5) of the supporter of combustion.

14. A device according to claim 12 or claim 13, comprising a fourth on-off valve (17) disposed downstream of the second modulator (16), in the circuit (5) of the supporter of combustion.
